(19) United States
(12) Patent Application Publication
(10) Pub. No.: US 2023/0334296 A1
(43) Pub. Date: Oct. 19, 2023

(54) METHODS AND APPARATUS FOR UNCERTAINTY ESTIMATION FOR HUMAN-IN-THE-LOOP AUTOMATION USING MULTI-VIEW BELIEF SYNTHESIS

(71) Applicant: Intel Corporation, Santa Clara, CA (US)

(72) Inventor: Anthony Rhodes, Portland, OR (US)

(21) Appl. No.: 18/334,232

(22) Filed: Jun. 13, 2023

(51) Int. Cl. G06N 3/0464

(52) U.S. Cl. CPC G06N 3/0464

(57) ABSTRACT

Methods, apparatus, and systems are disclosed for uncertainty estimation for human-in-the-loop automation (e.g., a human user or a machine user interview) using multi-view belief synthesis. An example apparatus includes at least one memory, machine readable instructions, and programmable circuitry to at least one of instantiate or execute the machine readable instructions to receive input from a deep learning network, perform dissonance regularization to the input from the deep learning network, the dissonance regularization including a multi-view belief fusion, identify a loss function constraint based on the dissonance regularization, apply the identified loss function constraint during training of a viewpoint model, and initiate at least one user intervention based on a total vacuity threshold, the total vacuity threshold associated with the multi-view belief fusion.

### FIELD OF THE DISCLOSURE

This disclosure relates generally to software processing, and, more particularly, to methods, systems, and apparatus for uncertainty estimation for human-in-the-loop automation using multi-view belief synthesis.

### BACKGROUND

Deep neural networks (DNN) such as convolutional neural networks (CNNs) and recurrent neural networks (RNNs) can be used to provide accurate solutions for problems associated with a variety of fields, including image classification, speech recognition, medical diagnosis, and/or autonomous driving. Evidential Deep Learning represents a developing approach to efficiently produce uncertainty measures from deep learning models through explicit prediction of parameters from an evidential probability distribution that captures a high-order statistical structure of a sample of point estimates.

### BRIEF DESCRIPTION OF THE DRAWINGS

FIG. 1 is an example environment in which uncertainty estimation is performed using example uncertainty estimator circuitry in accordance with teachings disclosed herein.

FIG. 2 is a block diagram representative of the uncertainty estimator circuitry that may be implemented in the example environment of FIG. 1.

FIG. 3 is a flowchart representative of example machine-readable instructions and/or example operations that may be executed, instantiated, and/or performed by example programmable circuitry to implement the example uncertainty estimator circuitry of FIG. 1 to perform uncertainty estimation in accordance with teachings disclosed herein.

FIG. 4 is a flowchart representative of example machine-readable instructions and/or example operations that may be executed, instantiated, and/or performed by example programmable circuitry to implement the example uncertainty estimator circuitry of FIG. 1 to perform multi-view dissonance regularization in accordance with teachings disclosed herein.

FIG. 5 is a flowchart representative of example machine readable instructions which, when executed by a computing system of FIG. 2, cause the computing system to train a neural network to generate viewpoint model(s).

FIG. 6 is a flowchart representative of example machine-readable instructions and/or example operations that may be executed, instantiated, and/or performed by example programmable circuitry to implement the example uncertainty estimator circuitry of FIG. 1 to determine uninformed priors for belief synthesis in accordance with teachings disclosed herein.

FIG. 7 is a flowchart representative of example machine-readable instructions and/or example operations that may be executed, instantiated, and/or performed by example programmable circuitry to implement the example uncertainty estimator circuitry of FIG. 1 to identify total vacuity in accordance with teachings disclosed herein.

FIG. 8A illustrates an example three-dimensional confident Dirichlet prediction, conflicting Dirichlet prediction, and an out-of-distribution Dirichlet prediction.

FIG. 8B illustrates examples of a confident prediction, a conflicting prediction, and a Dirichlet prediction using Evidential Deep Learning (EVDL).

FIG. 9 illustrates example entropy, dissonance, and vacuity in an EVDL framework.

FIG. 10 illustrates a baseline schematic for experimental action recognition workflow using a three-dimensional convolutional neural network backbone, temporal convolutional network streams, and a multi-view belief synthesis process in accordance with teachings disclosed herein.

FIG. 11 illustrates example performance results for baseline multi-view belief synthesis and total vacuity for human-in-the-loop (HITL) intervention.

FIG. 12 is a block diagram of an example processing platform including programmable circuitry structured to execute, instantiate, and/or perform the example machine readable instructions and/or perform the example operations of FIGS. 3-7 to implement the example uncertainty estimator circuitry of FIG. 1 to perform uncertainty estimation in accordance with teachings disclosed herein.

FIG. 13 is a block diagram of an example processing platform structured to execute the instructions of FIG. 5 to implement the computing system of FIG. 2.

FIG. 14 is a block diagram of an example implementation of the programmable circuitry of FIGS. 12 and 13.

FIG. 15 is a block diagram of another example implementation of the programmable circuitry of FIGS. 12 and 13.

FIG. 16 is a block diagram of an example software/firmware/instructions distribution platform (e.g., one or more servers) to distribute software, instructions, and/or firmware (e.g., corresponding to the example machine readable instructions of FIGS. 3-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Deep neural networks (DNNs) have allowed for state-of-the-art accuracy to be achievable for a wide range of tasks. However, the wholesale adoption of future artificial intelligence (AI)-based systems in real-world settings that encompass vital fields such as safety critical processes (e.g., autonomous driving) and/or human-in-the-loop (HITL) workflows (e.g., AI-assisted medical diagnostics) is strongly contingent on their “trustworthiness”. For example, in addition to exhibiting high performance grades (e.g., classification accuracy, precision) on real-world data, practical AI systems should be developed to provide nuanced guidance pertaining to the uncertainty of their predictions. For example, AI systems should competently “know what they don't know”. Among other applications, the so-called “known unknowns” understanding can be employed for anomaly detection, to improve general model performance, enhance model calibration properties, trigger human intervention/annotation for HITL use cases, and detect data novelty/out-of-distribution (OOD) for continuous learning processes. In some examples, a large gap exists between “research” model performance and “real-world” model performance due to several factors, including the inherent challenges of OOD learning, long tail distributions, and weak calibration properties of many state-of-the-art models. For example, conventional Deep Learning (DL) practice narrowly constrains a model to output predictive class probabilities following the application of a softmax function. Given that a softmax output represents a point estimate, it does not explicitly render a reliable and robust source of uncertainty estimation. Moreover, such a brittle point estimate often fails to capture informative, higher-order structures that embody statistical properties evinced at a class and dataset level, including a means to predict OOD and novel data classes.

Evidential Deep Learning (EVDL) represents a developing approach to efficiently produce uncertainty measures from DL models through an explicit prediction of parameters from an evidential probability distribution that captures the high-order statistical structure of a sample of point estimates. While EVDL furnishes several efficiency and modeling benefits over alternative DL uncertainty approaches, including Bayesian Deep Learning (BNN) and ensembling, EVDL is nevertheless susceptible to model performance degradation since a single, deterministic model is used to maintain a concurrent capacity for both high predictive performance and uncertainty estimation. Despite many theoretical benefits, EVDL is a burgeoning paradigm for generating uncertainty estimates from DL models, and thus some of these inherent challenges (and solutions) are underdeveloped.

Overall, neural network (NN)-based uncertainty can be defined based on two axes: (1) uncertainty in the data (e.g., aleatoric uncertainty), and (2) uncertainty in prediction, known as epistemic uncertainty. Representations of aleatoric uncertainty can be learned directly from data, whereas epistemic uncertainty can be derived in a variety of ways, including (1) BNNs, which learn probabilistic priors over network weights and employ sampling schemes to approximate predictive uncertainty, and (2) ensembling, which amounts to training a set of models and then deriving the uncertainty estimates from the predictive variance. The former case presents several limitations, including the intractability of directly solving for the predictive posterior distribution of the model weights, determining appropriate prior distributions, and the required computational cost of sampling (e.g., Monte Carlo Markov Chain (MCMC) sampling). For example, the latter case of ensembling necessitates training an ensemble of models, resulting in a high computational cost. However, resulting quality of the uncertainty measures derived from ensembling scales according to the size of the ensemble (e.g., the total number of trained models).

Conversely, EVDL casts learning as an evidence acquisition process. In this way, training examples lend support to a higher-order evidential probability distribution that is directly learned by the model through the prediction of evidential hyperparameters. For example, these high-order evidential distributions can be represented as instantiations of distributions from which a dataset is drawn. As such, by training a neural network to predict the hyperparameters governing this higher-order evidential distribution, it is possible to generate representations of epistemic and aleatoric uncertainty in a computationally efficient way, in the absence of additional sampling procedures or ensembling. Additionally, EVDL can be applied to classification or regression problems.

Methods and apparatus disclosed herein perform uncertainty estimation for human-in-the-loop (HITL) automation using multi-view belief synthesis by focusing on enhancing EVDL-based approaches for use during classification. In examples disclosed herein, multi-view dissonance regularization, uniformed priors for belief synthesis, and total vacuity for HITL applications is achieved. In examples disclosed herein, an end-to-end system leveraging lightweight, Temporal Convolutional Networks (TCNs) is introduced along with a framework for enabling HITL applications using estimated total vacuity of the multi-view automated system. In examples disclosed herein, dissonance regularization applies an additional learning constraint via a loss function to enforce the minimization of conflicting Dirichlet beliefs during model training, uniformed priors for belief synthesis enrich the fused evidential distributions learned by the system by penalizing the generation of evidence for misclassified data, and total vacuity provides an effective means to identify high degrees of epistemic uncertainty to prompt HITL intervention.

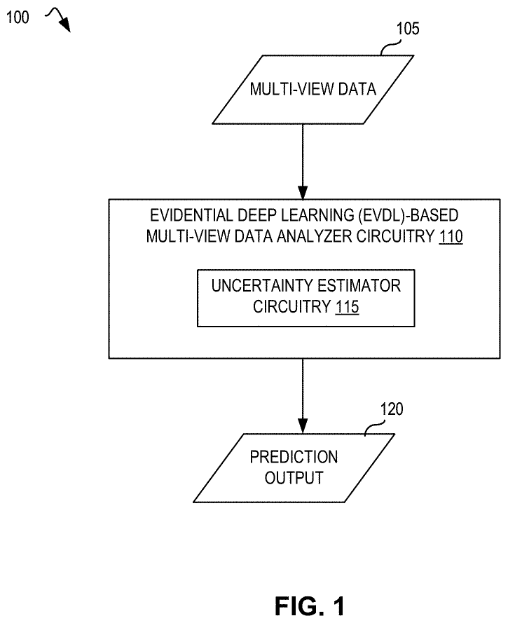

FIG. 1 is an example environment 100 in which uncertainty estimation is performed using example uncertainty estimator circuitry in accordance with teachings disclosed herein. In the example of FIG. 1, multi-view data 105 is input into an Evidential Deep Learning (EVDL)-based multi-view data analyzer circuitry 110. Data input into the EVDL-based multi-view data analyzer circuitry 110 is also processed using example uncertainty estimator circuitry 115 to obtain an uncertain estimate. A final prediction output 120 is obtained once processing of the input multi-view data 105 is completed.

In some examples, the multi-view data 105 includes video clips (e.g., associated with a video action segmentation task). In some examples, the EVDL-based multi-view data analyzer circuitry 110 outputs predictions of hyperparameters of a higher-order evidential distribution based on the input multi-view data 105. In the classification setting, the family of distributions commonly used for this purpose is the Dirichlet distribution. A Dirichlet distribution is a multivariate generalization of the Beta distribution, and as such, it is commonly encountered in multi-class classification problems throughout ML. For example, the Dirichlet distribution possesses many useful mathematical properties, including favorable conjugacy properties. The Dirichlet distribution can be defined in accordance with Equation 1:

$$Dir ( μ ; α ) = \frac{1}{β ( α )} {\prod }_{k = 1}^{K} {μ}_{k}^{{α}_{k} - 1} ; β ( α ) = \frac{{\prod }_{k = 1}^{K} Γ ( {α}_{k} )}{Γ ( {α}_{0} )} \qquad Equation 1$$

In the example of Equation 1, Γ(·) denotes a gamma function, K is a number of classes, and B(·) is a beta function, where each μᵢϵ[0,1], as each variable in the Dirichlet distribution can be considered a Beta random variable on its own. Furthermore, a unity constraint is introduced: Σᵢ₌₁^{K}μᵢ=1. A useful quantity in regard to the Dirichlet distribution is the so-called distribution “strength”, notated as follows: α₀=Σₖ₌₁^{K}αₖ. In the example of Equation 1, α₀ is the sum of the Dirichlet alpha parameters and therefore captures the “peakedness” of the Dirichlet distribution. Accordingly, an instance of the Dirichlet distribution with a large α₀ tends to be very peaked (e.g., sharp).

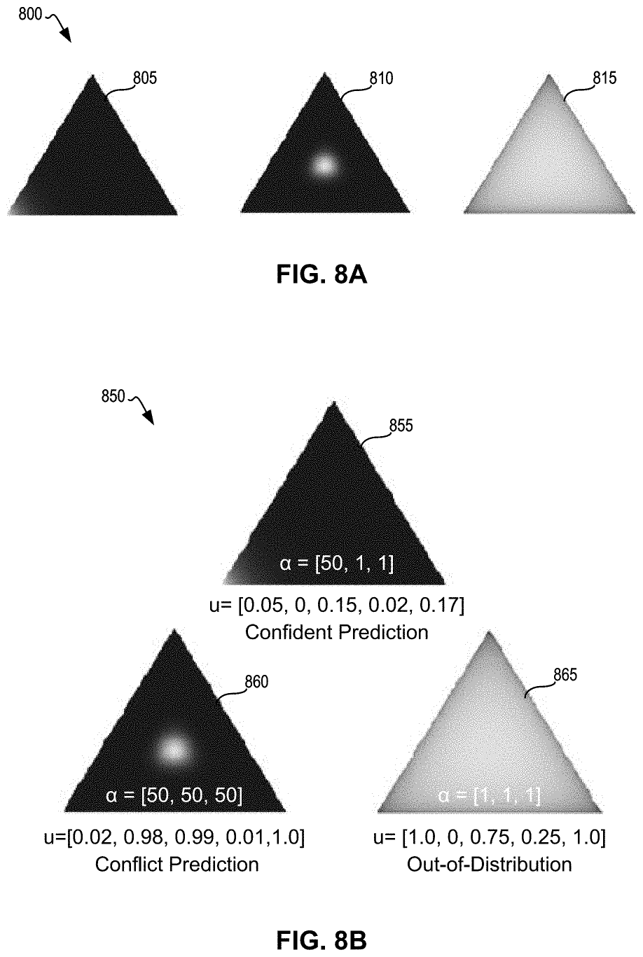

The support of the Dirichlet distribution in k-dimensions is a k-simplex. For a small number of dimensions (i.e., small k), it is helpful to visualize the support and morphology of the Dirichlet explicitly with regard to a k-simplex (e.g., a 3-simplex), as shown in connection with FIG. 8A, where instances of the Dirichlet distribution with different parameter values are shown to encapsulate cases reflecting confident predictions, (in distribution) conflicting predictions, and out-of-distribution (OOD) predictions. For example, for classification with K classes, a neural classifier can be used as a function mapping data points to k-dimensional logits. With EVDL, a common neural network (NN) architecture can be adapted to predict hyperparameters of Dirichlet distributions, without any major modifications. For example, to classify a datapoint x, the EVDL-based multi-view data analyzer circuitry 110 creates a categorical distribution from the predicted concentration parameters of the Dirichlet in accordance with Equation 2:

$$α = {f}_{θ} ( x ) ; {μ}_{k} = \frac{{α}_{k}}{{α}_{0}} ; \hat{y} = {arg max}_{k} {μ}_{1} , … , {μ}_{K} \qquad Equation 2$$

In the example of Equation 2, f_{θ}(x) represents the logit output of the model parameterized by θ, with respect to the input datum x. Furthermore, EVDL NNs can be conventionally trained using a means squared error (MSE) formulation shown in connection with Equation 3:

$$L ( {θ}_{i} ) = \int {‖ {y}_{i} - {μ}_{i} ‖}_{2}^{2} \frac{1}{β ( α )} {\prod }_{k = 1}^{K} {μ}_{ik}^{{α}_{ik} - 1} d {μ}_{i} = {\sum }_{k = 1}^{K} {( {y}_{ik} - {\hat{μ}}_{ik} )}^{2} + \frac{{\hat{μ}}_{ik} ( 1 - {\hat{μ}}_{ik} )}{{α}_{i 0}} \qquad Equation 3$$

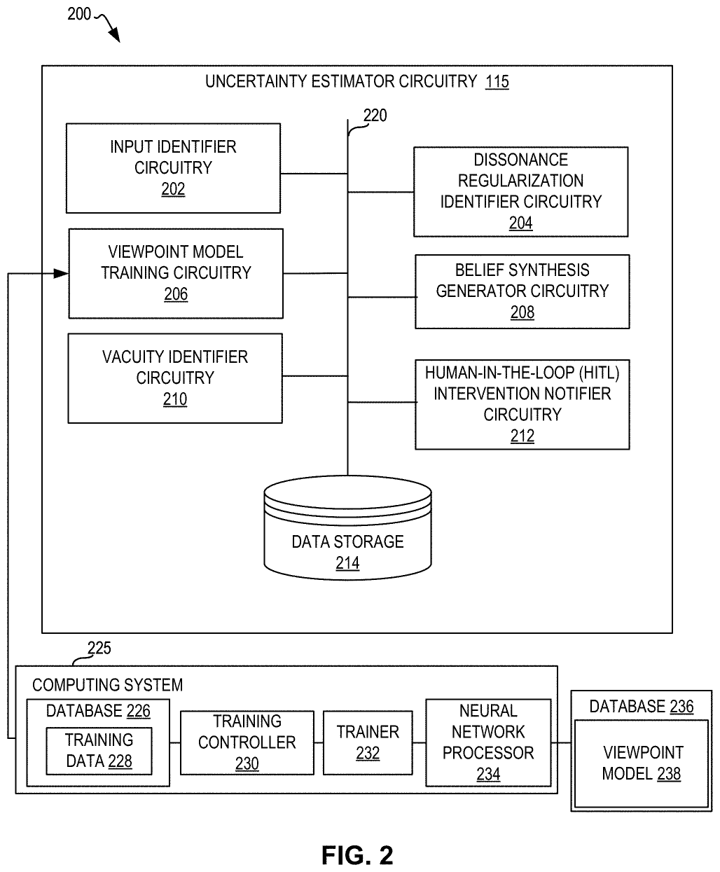

In some examples, the EVDL-based multi-view data analyzer circuitry 110 trains the model to produce high evidence for the ground-truth label class and low evidence for other class assignments (e.g., left term of equation (3)). In addition, MSE loss provides a form of baseline regularization by concurrently enforcing variance minimization of the implied Dirichlet distribution (e.g., right term of equation (3)). Together, these aspects of MSE help generate plausible evidential outputs so that the Dirichlet distribution captures the desired statistical structure of the dataset. However, in practice (and particularly when using challenging, real-world datasets), using MSE alone for EVDL often results in model performance degradation. As such, although the evidential NN is capable of outputting uncertainty estimates and making OOD predictions, it is nonetheless weaker as a predictive model, which diminishes the usefulness of its uncertainty and related estimates. In examples disclosed herein, the uncertainty estimator circuitry 115 introduces core novelties for EVDL, including (1) multi-view dissonance regularization, (2) uniformed priors for belief synthesis, and (3) total vacuity, as described in more detail in connection with FIG. 2.

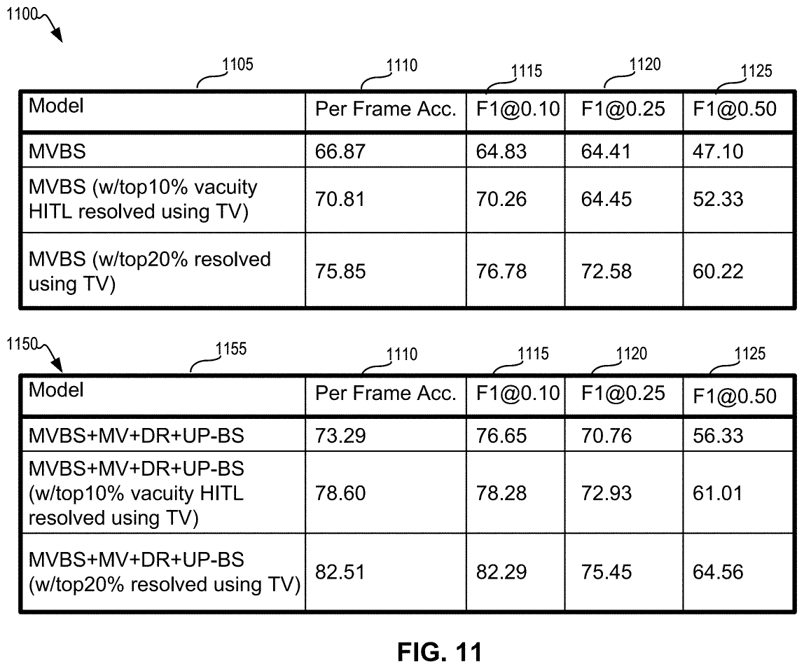

For example, the uncertainty estimator circuitry 115 uses dissonance regularization to apply an additional learning constraint via a loss function to enforce the minimization of conflicting Dirichlet beliefs during model training. In some examples, the dissonance regularization can be applied DR in two ways: (1) to improve individual (per-view) uncertainty estimation robustness, and (2) to additionally enhance the fused evidential belief surrounding action prediction. This constraint effectively increases the decision boundary margin for evidential data embeddings, improving the predictive performance of EVDL models while providing robust uncertainty estimates. Furthermore, the uncertainty estimator circuitry 115 uses uniformed priors for belief synthesis to enrich the fused evidential distributions learned by the system by penalizing the generation of evidence for misclassified data (e.g., to encourage the attribution of low evidence when the model has low prediction confidence). Additionally, the uncertainty estimator circuitry 115 uses total vacuity as a mechanism to identify high degrees of epistemic uncertainty to prompt HITL intervention. As shown in connection with FIG. 11, strong predictive performance is achieved using the methods and apparatus disclosed herein, in addition to robust and grounded uncertainty estimates that can be incorporated seamlessly into HITL processes.

FIG. 2 is a block diagram 200 of an example implementation of the uncertainty estimator circuitry 115 of FIG. 1. The uncertainty estimator circuitry 115 of FIG. 1 may be instantiated (e.g., creating an instance of, bring into being for any length of time, materialize, implement, etc.) by programmable circuitry such as a Central Processing Unit (CPU) executing first instructions. Additionally or alternatively, the uncertainty estimator circuitry 115 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The uncertainty estimator circuitry 115 includes example input identifier circuitry 202, example dissonance regularization identifier circuitry 204, example viewpoint model training circuitry 206, example belief synthesis generator circuitry 208, example vacuity identifier circuitry 210, example human-in-the-loop (HITL) intervention notifier circuitry 212, and example data storage 214. In the example of FIG. 2, the input identifier circuitry 202, the dissonance regularization identifier circuitry 204, the viewpoint model training circuitry 206, the belief synthesis generator circuitry 208, the vacuity identifier circuitry 210, the human-in-the-loop (HITL) intervention notifier circuitry 212, and the data storage 214 are in communication using an example bus 220.

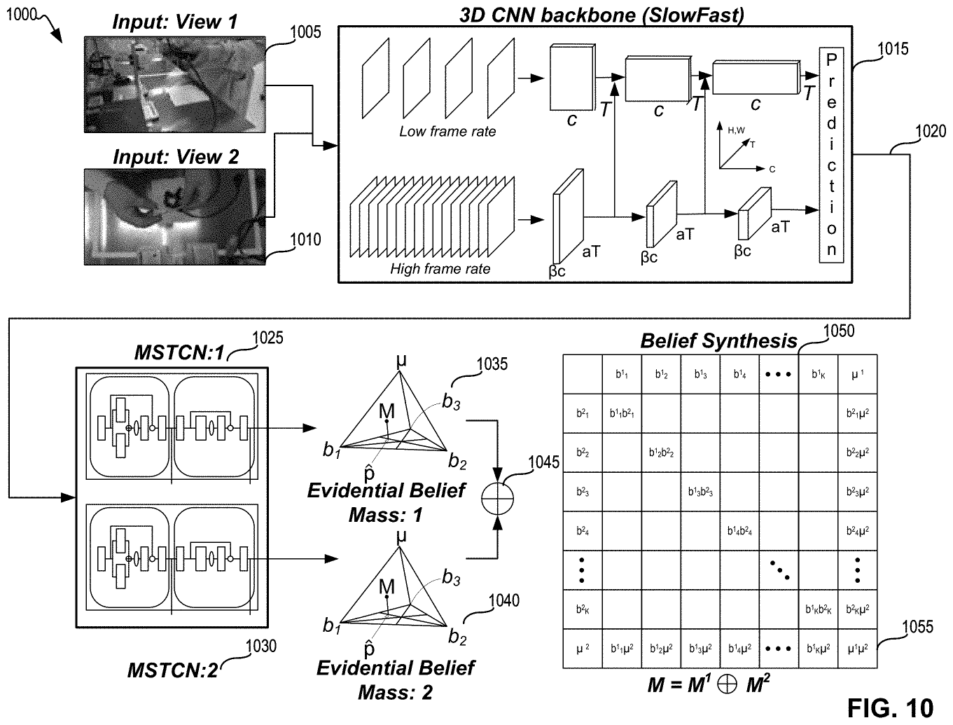

The input identifier circuitry 202 receives input from the EVDL-based multi-view data analyzer circuitry 110. For example, the input identifier circuitry 202 receives input associated with the multi-view data 105 of FIG. 1. In some examples, the input identifier circuitry 202 receives processing results obtained from a three-dimensional convolutional neural network (CNN) backbone associated with the EVDL-based multi-view data analyzer circuitry 110. For example, the input identifier circuitry 202 receives a prediction output generated as a result of low frame rate processing and high frame rate processing, as shown in connection with FIG. 10.

The dissonance regularization identifier circuitry 204 improves individual (per-view) uncertainty estimation robustness and enhances the fused evidential belief surrounding action prediction. As previously mentioned, evidential NNs output hyperparmeter estimates of evidential Dirichlet distributions that capture higher-order statistical structure of a sample of point estimates. Directly modeling this higher-order structure endows the model with additional epistemological capacities to quantify degrees of predictive uncertainty and to recognize OOD and novel data. For example, e=RELU(f_{θ}(x)) denotes an evidence vector produced by the evidential NN with parameters θ for the input datum x. f_{θ}(x) is the output logit (i.e., no softmax is applied). e is the result of applying RELU to this output logit, where e∈R₊^{K}, such that e is a k-dimensional evidence vector, where each evidence component is non-negative. Applying Dempster-Shafer Theory of Evidence (DST), an overall uncertainty mass u≥0 can be identified, reflecting the predictive uncertainty determined by the evidence e generated by the model. In particular, the dissonance regularization identifier circuitry 204 determines a constraint in accordance with Equation 4, where bₖ≥0 for each k=1, . . . , K:

u+Σₖ₌₁^{K}bₖ=1 Equation 4

Likewise, the dissonance regularization identifier circuitry 204 determines a belief mass for a singleton k, computed using the evidence for the singleton, in accordance with Equation 5:

$${b}_{k} = \frac{{e}_{k}}{S} , where S = {\sum }_{i = 1}^{K} ( {e}_{i} + 1 ) \qquad Equation 5$$

As such, directly solving for uncertainty yields Equation 6, where u is the predictive vacuity of the model for the input datum x. Thus, vacuity represents a lack of evidence caused by insufficient information or knowledge to understand or analyze a given opinion.

$$u = \frac{K}{S} \qquad Equation 6$$

In some examples, the dissonance regularization identifier circuitry 204 determines dissonance of a multinomial opinion from the same amount of conflicting evidence and can estimate the dissonance based on the difference between singleton belief masses, as shown in connection with Equation 7:

$$diss ( b ) = {\sum }_{i = 1}^{K} ( \frac{{b}_{i} {\sum }_{j \neq i} Bal ( {b}_{j} , {b}_{i} )}{{\sum }_{j \neq i} {b}_{j}} ) , \\ where Bal ( {b}_{j} , {b}_{i} ) = 1 - \frac{\vert {b}_{j} - {b}_{i} \vert}{{b}_{j} + {b}_{i}} \qquad Equation 7$$

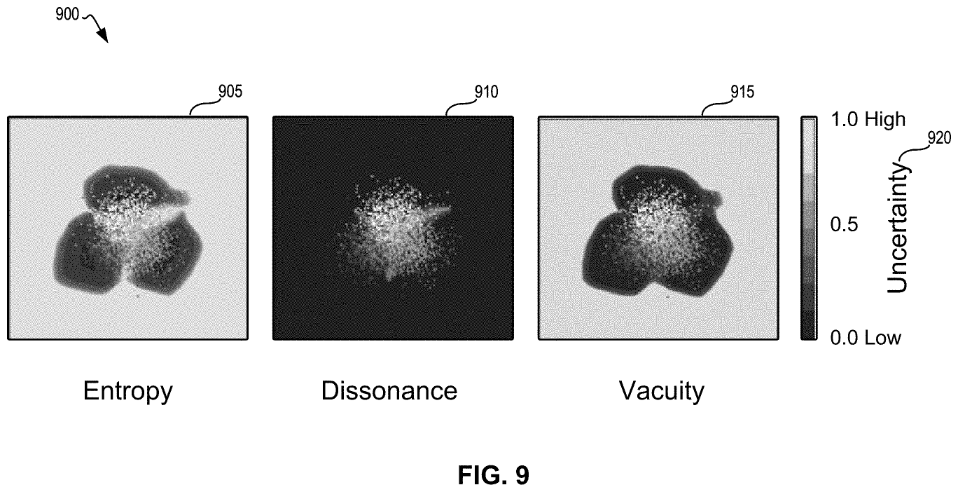

For example, dissonance provides a way to quantify conflicting beliefs by calculating a weighted belief “disagreement”. Specifically, strongly differing belief states produce a large Bal(bⱼ, bᵢ) score, which in turn yields a large dissonance. Large dissonance generally indicates sufficient evidence with conflicting beliefs, whereas high vacuity is indicative of OOD or novel data. In examples disclosed herein, dissonance and vacuity together provide favorable decomposition properties to enhance the understanding of model uncertainty, as described in more detail in connection with FIGS. 8B and 9.

In examples disclosed herein, the dissonance regularization identifier circuitry 204 uses dissonance regularization to introduce evidential dissonance as a regularization constraint, with the reduction of dissonance serving to maximize per-class margins of the data embeddings produced by an evidential model, thereby generating a more robust model. In some examples, the dissonance regularization identifier circuitry 204 follows Dempster's combination rule for fusing independent beliefs. For example, given two belief masses (i.e., evidential distributions corresponding with different viewpoints) denoted M¹={{bₖ¹}ₖ₌₁^{K}, u¹} and M²={{bₖ²}ₖ₌₁^{K}, u²}, respectively, the dissonance regularization identifier circuitry 204 determines a joint mass in accordance with Equation 8, where C=Σ_{i≠j}bᵢ¹bⱼ²:

$$M = {M}^{1} ⊕ {M}^{2} : {b}_{k} = \frac{1}{1 - C} ( {b}_{k}^{1} {b}_{k}^{2} + {b}_{k}^{1} {u}^{2} + {b}_{k}^{2} {u}^{1} ) \qquad Equation 8$$

In examples disclosed herein, the dissonance regularization identifier circuitry 204 defines multi-view dissonance regularization (MV-DR) through the following loss function constraint, as shown in connection with Equation 9:

$${L}_{MVDR} ( {θ}_{i} ) = {\sum }_{v = 1}^{2} ( {\sum }_{k = 1}^{K} {( {y}_{ik} - {\hat{μ}}_{ik}^{v} )}^{2} + \frac{{\hat{μ}}_{ik}^{v} ( 1 - {\hat{μ}}_{ik}^{v} )}{{α}_{i 0}^{v}} + {λ}^{v} {\sum }_{i = 1}^{K} ( \frac{{b}_{i}^{v} {\sum }_{j \neq i} Bal ( {b}_{j}^{v} , {b}_{i}^{v} )}{{\sum }_{j \neq i} {b}_{j}^{v}} ) ) + {\sum }_{k = 1}^{K} {( {y}_{ik} - {\hat{μ}}_{ik} )}^{2} + \frac{{\hat{μ}}_{ik} ( 1 - {\hat{μ}}_{ik} )}{{α}_{i 0}} + λ {\sum }_{i = 1}^{K} ( \frac{{b}_{i} {\sum }_{j \neq i} Bal ( {b}_{j} , {b}_{i} )}{{\sum }_{j \neq i} {b}_{j}} ) \qquad Equation 9$$

In the example of Equation 9, the first sum is over the viewpoints, and the latter term pertains to the synthesized, multi-view joint mass, and A is a hyperparameter gauging the importance of MV-DR during model training.

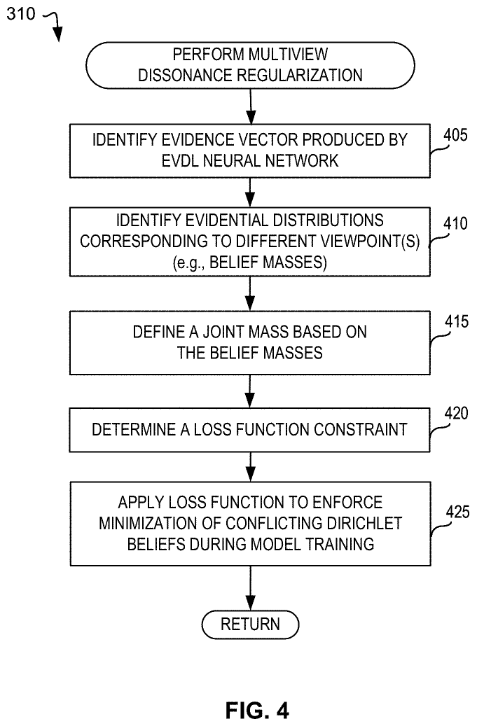

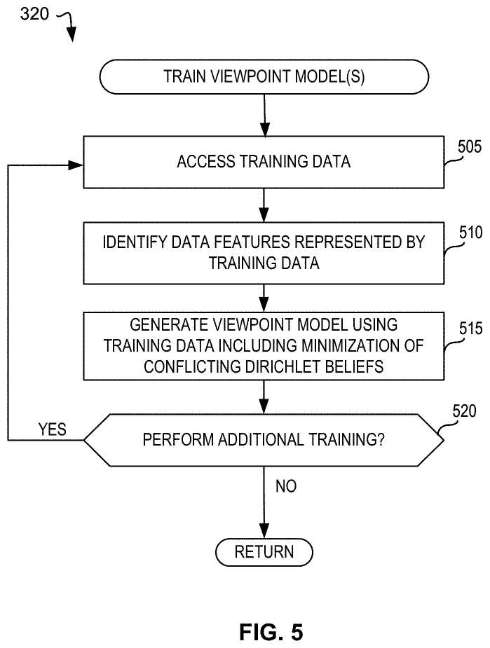

The viewpoint model training circuitry 206 performs training of the viewpoint model. In some examples, the viewpoint model training circuitry 206 trains the viewpoint model(s) to minimize conflicting Dirichlet beliefs. For example, the loss function generated by the dissonance regularization identifier circuitry 204 can be applied during training of the viewpoint model(s), as described in more detail in connection with FIGS. 4-5. As illustrated in FIG. 2, the viewpoint model training circuitry 206 is in communication with a computing system 225 that trains a neural network. As disclosed herein, the viewpoint model training circuitry 206 implements a loss function during training of the viewpoint model(s).

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, deep neural network models are used. In general, machine learning models/architectures that are suitable to use in the example approaches disclosed herein will be based on supervised learning. However, other types of machine learning models could additionally or alternatively be used such as, for example, semi-supervised learning.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, any training algorithm may be used. In examples disclosed herein, training can be performed based on early stopping principles in which training continues until the model(s) stop improving. In examples disclosed herein, training can be performed remotely or locally. In some examples, training may initially be performed remotely. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) are used. Such hyperparameters are selected by, for example, random searching and/or prior knowledge. In some examples re-training may be performed. Such re-training may be performed in response to new input datasets, drift in the model performance, and/or updates to model criteria and system specifications.

Training is performed using training data. In examples disclosed herein, the training data originates from previously generated images that include subject(s) in different 2D and/or 3D pose(s), image data with different resolutions, images with different numbers of subjects captured therein, etc. In some examples, the training data is labeled. In some examples, the training data is sub-divided such that a portion of the data is used for validation purposes.

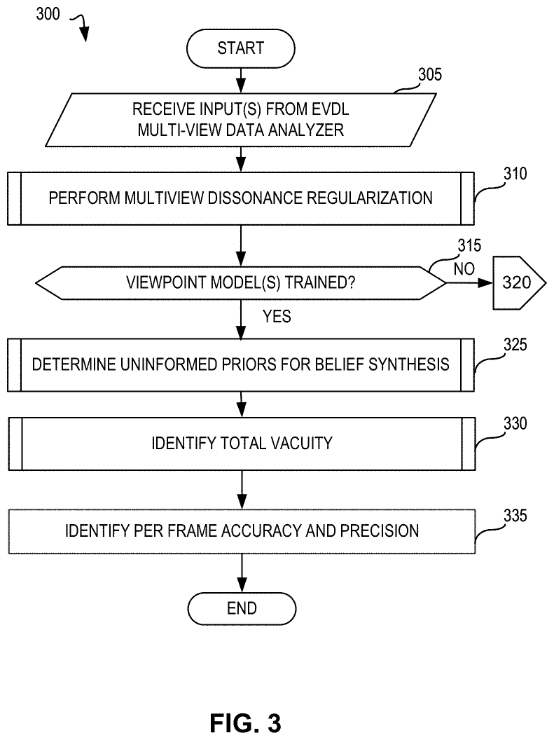

Once training is complete, the viewpoint model(s) are stored in one or more databases (e.g., database 236 of FIG. 3). One or more of the models may then be executed by, for example, the uncertainty estimator circuitry 115 of FIG. 2. Once trained, the deployed model(s) may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 2, the computing system 225 trains a neural network to generate a viewpoint model 238. In examples disclosed herein, the viewpoint model is based on a temporal convolutional network (TCN). However, any other type of neural network can be used. The example computing system 225 includes a neural network processor 234. In examples disclosed herein, the neural network processor 234 implements a neural network. The computing system 225 of FIG. 2 also includes a neural network trainer 232. The neural network trainer 232 of FIG. 2 performs training of the neural network implemented by the neural network processor 234.

The computing system 225 of FIG. 2 includes a training controller 230. The training controller 230 instructs the neural network trainer 232 to perform training of the neural network based on training data 228. In the example of FIG. 2, the training data 228 used by the neural network trainer 232 to train the neural network is stored in a database 226. The example database 226 of the illustrated example of FIG. 2 is implemented by any memory, storage device and/or storage disc for storing data such as, for example, flash memory, magnetic media, optical media, etc. Furthermore, the data stored in the example database 226 may be in any data format such as, for example, binary data, comma delimited data, tab delimited data, structured query language (SQL) structures, image data, etc. While the illustrated example database 226 is illustrated as a single element, the database 226 and/or any other data storage elements described herein may be implemented by any number and/or type(s) of memories. In the example of FIG. 2, the training data 228 can include image data and video sequence frame data. In some examples, the training data 228 includes multi-view data (e.g., video clips for purposes of video action segmentation). The neural network trainer 232 trains the neural network implemented by the neural network processor 234 using the training data 228 to generate a viewpoint model 238 as a result of the neural network training. The viewpoint model 238 is stored in a database 236. The databases 226, 236 may be the same storage device or different storage devices.

The belief synthesis generator circuitry 208 performs uninformed prior-based belief synthesis. For example, uninformed prior evidential distributions are helpful to reduce the instance of the spurious evidence being generated by the model in the case of misclassification. In some examples, the belief synthesis generator circuitry 208 adopts the framework of uninformed (i.e., uniform) prior regularization for EVDL for use in a multi-tiered fashion so that each viewpoint model (e.g., temporal convolutional network, TCN) is regularized. As such, uninformed prior regularization is introduced for the belief synthesis process. In examples disclosed herein, the belief synthesis generator circuitry 208 defines performs uninformed prior-based belief synthesis (UP-BS) in accordance with Equation 10, where φ(·) is a digamma function, Γ(·) is a gamma function, and \tilde{α}ᵢ=yᵢ+(1−yᵢ)⊙αᵢ:

$${L}_{UPBS} ( {θ}_{i} ) = {\sum }_{v = 1}^{2} {β}^{v} ( log ( \frac{Γ ( {\sum }_{k = 1}^{K} {\tilde{α}}_{ik}^{v} )}{Γ ( K ) {\prod }_{k = 1}^{K} Γ ( {\tilde{α}}_{ik}^{v} )} ) + \qquad Equation 10$$

$${\sum }_{k = 1}^{K} ( {\tilde{α}}_{ik}^{v} - 1 ) [ φ ( {\tilde{α}}_{ik}^{v} ) - φ ( {\sum }_{j = 1}^{K} {\tilde{α}}_{ij}^{v} ) ] ) +$$

$$β log ( \frac{Γ ( {\sum }_{k = 1}^{K} {\tilde{α}}_{ik} )}{Γ ( K ) {\prod }_{k = 1}^{K} Γ ( {\tilde{α}}_{ik} )} ) + {\sum }_{k = 1}^{K} ( {\tilde{α}}_{ik} - 1 ) [ φ ( {\tilde{α}}_{ik} ) - φ ( {\sum }_{j = 1}^{K} {\tilde{α}}_{ij} ) ]$$

The vacuity identifier circuitry 210 determines a total vacuity associated with human-in-the-loop (HITL) intervention. For example, following the multi-view belief fusion operation defined in Equation 8, the vacuity identifier circuitry 210 determines the corresponding total vacuity (TV) in accordance with Equation 11:

$${u}^{*} = \frac{{u}^{1} {u}^{2}}{K ( C - 1 )} \qquad Equation 11$$

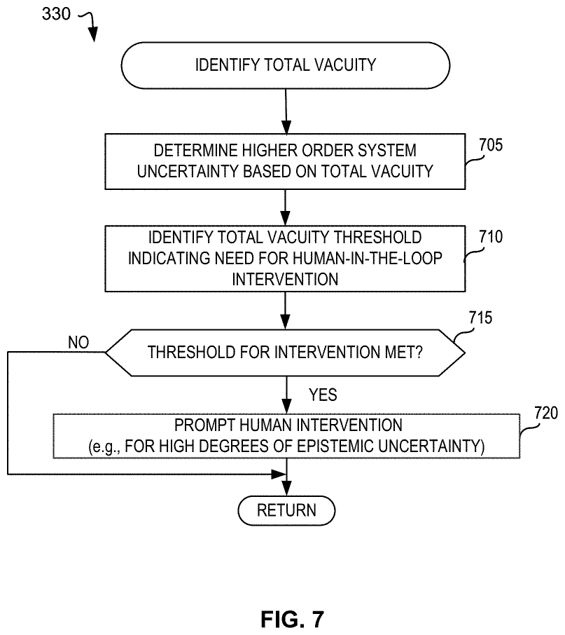

For example, TV represents a higher-order, system-based uncertainty following the belief synthesis process. For this reason, TV can be used as a trustworthy mechanism to identify high degrees of system-wide epistemic uncertainty to prompt HITL intervention, as described in more detail in connection with FIG. 7.

The human-in-the-loop (HITL) intervention notifier circuitry 212 uses the total vacuity determined by the vacuity identifier circuitry 210 to identify cases where HITL intervention can be performed. For example, the HITL intervention notifier circuitry 212 thresholds the TV to indicate that human annotation or guidance is recommended (e.g., if u*>τ: prompt HITL guidance).

The data storage 214 can be used to store any information associated with the input identifier circuitry 202, the dissonance regularization identifier circuitry 204, the viewpoint model training circuitry 206, the belief synthesis generator circuitry 208, the vacuity identifier circuitry 210, and the human-in-the-loop (HITL) intervention notifier circuitry 212. The example data storage 214 of the illustrated example of FIG. 2 can be implemented by any memory, storage device and/or storage disc for storing data such as flash memory, magnetic media, optical media, etc. Furthermore, the data stored in the example data storage 214 can be in any data format such as binary data, comma delimited data, tab delimited data, structured query language (SQL) structures, image data, etc.

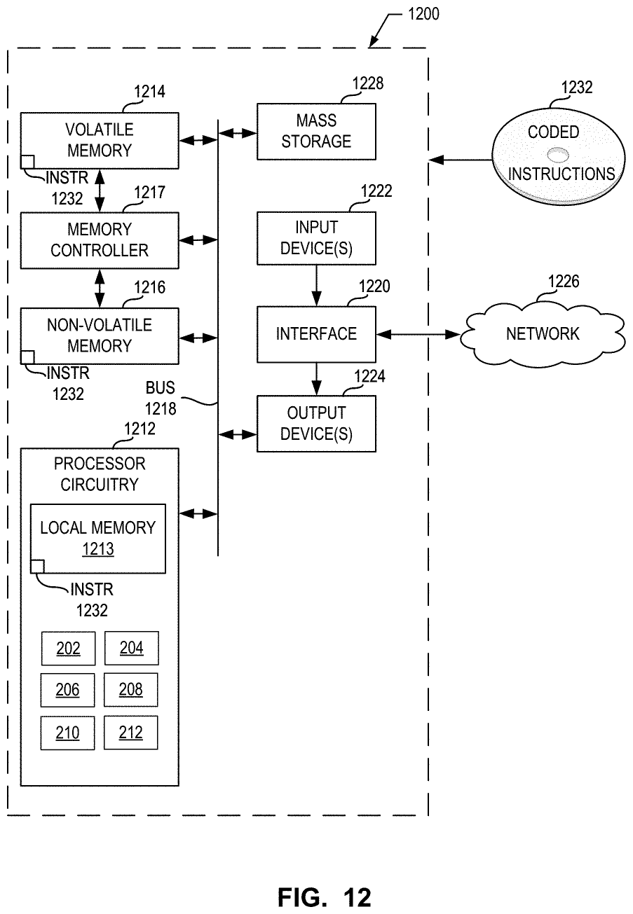

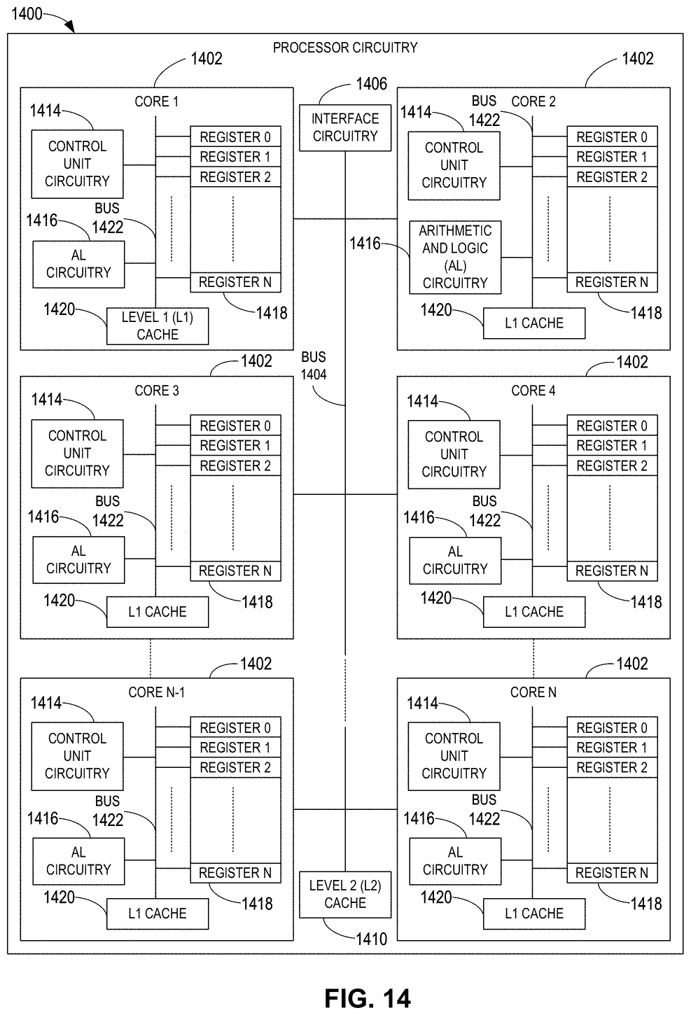

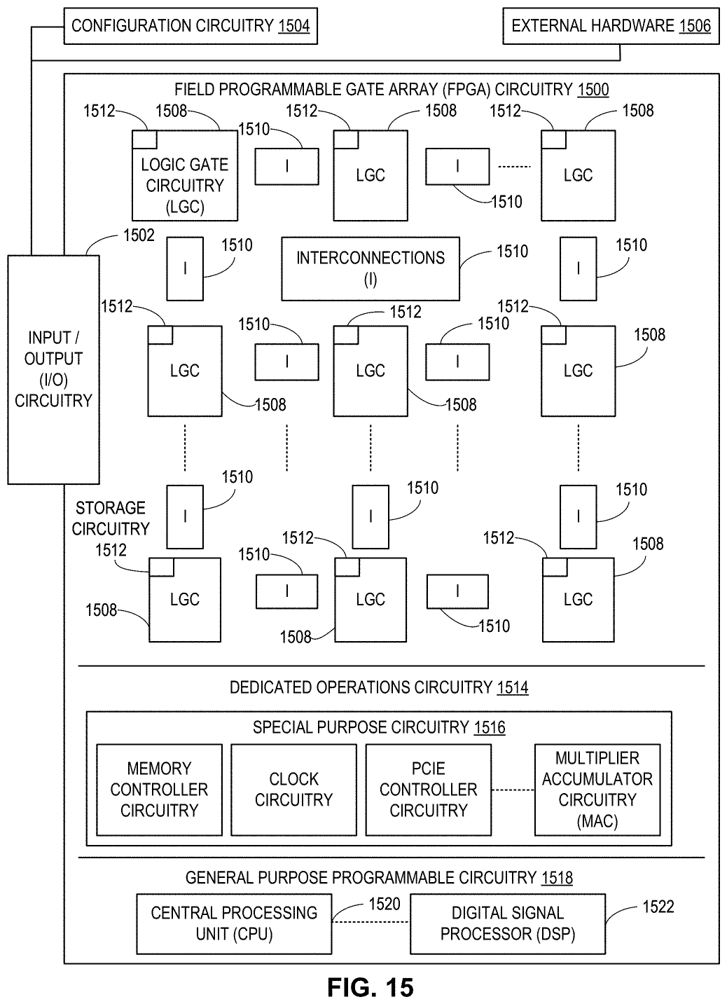

In some examples, the apparatus includes means for identifying input. For example, the means for identifying input may be implemented by input identifier circuitry 202. In some examples, the input identifier circuitry 202 may be instantiated by programmable circuitry such as the example programmable circuitry 1212 of FIG. 12. For instance, the input identifier circuitry 202 may be instantiated by the example microprocessor 1400 of FIG. 14 executing machine executable instructions such as those implemented by at least block 305 of FIG. 3. In some examples, the input identifier circuitry 202 may be instantiated by hardware logic circuitry, which may be implemented by an ASIC, XPU, or the FPGA circuitry 1500 of FIG. 15 structured to perform operations corresponding to the machine readable instructions. Additionally or alternatively, the input identifier circuitry 202 may be instantiated by any other combination of hardware, software, and/or firmware. For example, the input identifier circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for performing dissonance regularization. For example, the means for performing dissonance regularization may be implemented by dissonance regularization identifier circuitry 204. In some examples, the dissonance regularization identifier circuitry 204 may be instantiated by programmable circuitry such as the example programmable circuitry 1212 of FIG. 12. For instance, the dissonance regularization identifier circuitry 204 may be instantiated by the example microprocessor 1400 of FIG. 14 executing machine executable instructions such as those implemented by at least block 310 of FIG. 3. In some examples, the dissonance regularization identifier circuitry 204 may be instantiated by hardware logic circuitry, which may be implemented by an ASIC, XPU, or the FPGA circuitry 1500 of FIG. 15 structured to perform operations corresponding to the machine readable instructions. Additionally or alternatively, the dissonance regularization identifier circuitry 204 may be instantiated by any other combination of hardware, software, and/or firmware. For example, the dissonance regularization identifier circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for training a viewpoint model. For example, the means for training a viewpoint model may be implemented by viewpoint model training circuitry 206. In some examples, the viewpoint model training circuitry 206 may be instantiated by programmable circuitry such as the example programmable circuitry 1212 of FIG. 12. For instance, the viewpoint model training circuitry 206 may be instantiated by the example microprocessor 1400 of FIG. 14 executing machine executable instructions such as those implemented by at least block 515 of FIG. 5. In some examples, the viewpoint model training circuitry 206 may be instantiated by hardware logic circuitry, which may be implemented by an ASIC, XPU, or the FPGA circuitry 1500 of FIG. 15 structured to perform operations corresponding to the machine readable instructions. Additionally or alternatively, the viewpoint model training circuitry 206 may be instantiated by any other combination of hardware, software, and/or firmware. For example, the viewpoint model training circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for performing belief synthesis. For example, the means for performing belief synthesis may be implemented by belief synthesis generator circuitry 208. In some examples, the belief synthesis generator circuitry 208 may be instantiated by programmable circuitry such as the example programmable circuitry 1212 of FIG. 12. For instance, the viewpoint model training circuitry 206 may be instantiated by the example microprocessor 1400 of FIG. 14 executing machine executable instructions such as those implemented by at least block 325 of FIG. 3. In some examples, the belief synthesis generator circuitry 208 may be instantiated by hardware logic circuitry, which may be implemented by an ASIC, XPU, or the FPGA circuitry 1500 of FIG. 15 structured to perform operations corresponding to the machine readable instructions. Additionally or alternatively, the belief synthesis generator circuitry 208 may be instantiated by any other combination of hardware, software, and/or firmware. For example, the belief synthesis generator circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying vacuity. For example, the means for identifying vacuity may be implemented by vacuity identifier circuitry 210. In some examples, the vacuity identifier circuitry 210 may be instantiated by programmable circuitry such as the example programmable circuitry 1212 of FIG. 12. For instance, the vacuity identifier circuitry 210 may be instantiated by the example microprocessor 1400 of FIG. 14 executing machine executable instructions such as those implemented by at least block 330 of FIG. 3. In some examples, the vacuity identifier circuitry 210 may be instantiated by hardware logic circuitry, which may be implemented by an ASIC, XPU, or the FPGA circuitry 1500 of FIG. 15 structured to perform operations corresponding to the machine readable instructions. Additionally or alternatively, the vacuity identifier circuitry 210 may be instantiated by any other combination of hardware, software, and/or firmware. For example, the vacuity identifier circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying HITL intervention. For example, the means for identifying HITL intervention may be implemented by HITL intervention notifier circuitry 212. In some examples, the HITL intervention notifier circuitry 212 may be instantiated by programmable circuitry such as the example programmable circuitry 1212 of FIG. 12. For instance, the HITL intervention notifier circuitry 212 may be instantiated by the example microprocessor 1400 of FIG. 14 executing machine executable instructions such as those implemented by at least block 330 of FIG. 3. In some examples, the HITL intervention notifier circuitry 212 may be instantiated by hardware logic circuitry, which may be implemented by an ASIC, XPU, or the FPGA circuitry 1500 of FIG. 15 structured to perform operations corresponding to the machine readable instructions. Additionally or alternatively, the HITL intervention notifier circuitry 212 may be instantiated by any other combination of hardware, software, and/or firmware. For example, the HITL intervention notifier circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing uncertainty estimator circuitry 115 of FIG. 1 is illustrated in FIG. 2, one or more of the elements, processes and/or devices illustrated in FIG. 2 may be combined, divided, re-arranged, omitted, eliminated and/or implemented in any other way. Further, the example input identifier circuitry 202, example dissonance regularization identifier circuitry 204, example viewpoint model training circuitry 206, example belief synthesis generator circuitry 208, example vacuity identifier circuitry 210, example HITL intervention notifier circuitry 212, and/or, more generally, the example uncertainty estimator circuitry 115 of FIG. 2 may be implemented by hardware, software, firmware and/or any combination of hardware, software and/or firmware. Thus, for example, any of the example input identifier circuitry 202, example dissonance regularization identifier circuitry 204, example viewpoint model training circuitry 206, example belief synthesis generator circuitry 208, example vacuity identifier circuitry 210, example HITL intervention notifier circuitry 212, and/or, more generally, the example uncertainty estimator circuitry 115 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the uncertainty estimator circuitry 115 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the uncertainty estimator circuitry 115 of FIG. 2 and/or representative of example operations which may be performed by programmable circuitry to implement and/or instantiate the uncertainty estimator circuitry 115 of FIG. 2, are shown in FIGS. 3-7. The machine readable instructions may be one or more executable programs or portion(s) of one or more executable programs for execution by programmable circuitry, such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 3-4, many other methods of implementing the example uncertainty estimator circuitry 115 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to implement the example uncertainty estimator circuitry 115 of FIG. 2. The machine readable instructions and/or the operations 300 of FIG. 3 begin at block 305, at which the input identifier circuitry 202 receives input(s) from the Evidential Deep Learning (EVDL) multi-view data analyzer circuitry 110 of FIG. 1. In some examples, the input identifier circuitry 202 receives data associated with multi-view analysis focusing on assessment of video sequences received as part of the multi-view data input 105 of FIG. 1. For example, the input identifier circuitry 202 accesses results of a convolutional neural network (CNN) process performed on the input multi-view data 105, as shown in more detail in connection with FIG. 10. In some examples, the input data includes prediction uncertainty assessment obtained using the EVDL framework. The dissonance regularization identifier circuitry 204 performs multi-view dissonance regularization on the input data (block 310). For example, the dissonance regularization identifier circuitry 204 determines a loss function to implement during training of the viewpoint model(s) to enforce minimization of confliction Dirichlet beliefs, as described in more detail in connection with FIG. 4. In the example of FIG. 3, the viewpoint model training circuitry 206 determines whether the viewpoint model(s) have been trained (block 315) and proceeds to train the viewpoint model(s) (block 320), as described in connection with FIG. 5. For example, the viewpoint model training circuitry 206 applies the loss function determined using the dissonance regularization identifier circuitry 204 during training.

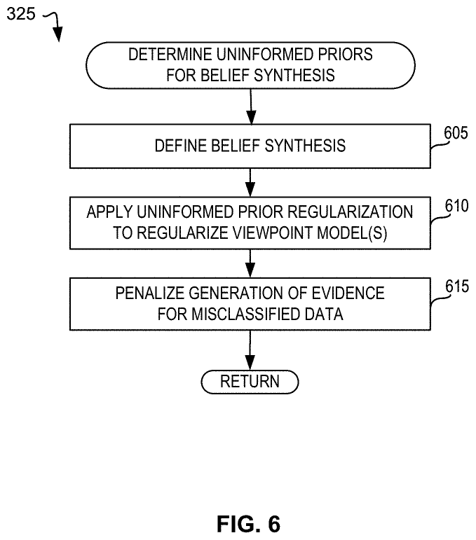

The belief synthesis generator circuitry 208 determines uninformed priors for belief synthesis (block 325). For example, the belief synthesis generator circuitry 208 reduces instances of spurious evidence being generated by the model in case of misclassification, as shown in more detail in connection with FIG. 6. In some examples, the belief synthesis generator circuitry 208 adopts the framework of uninformed (i.e., uniform) prior regularization for EVDL for use in a multi-tiered fashion so that each viewpoint model (e.g., temporal convolutional network, TCN) is regularized. The vacuity identifier circuitry 210 determines a total vacuity associated with human-in-the-loop (HITL) intervention (block 330). For example, the vacuity identifier circuitry 210 determines a total vacuity that represents a higher-order, system-based uncertainty following the belief synthesis process, as shown in more detail in connection with FIG. 7. Furthermore, the human-in-the-loop (HITL) intervention notifier circuitry 212 identities high degree(s) of system-wide epistemic uncertainty to prompt HITL intervention. In some examples, the HITL intervention notifier circuitry 212 identifies per frame accuracy and precision to determine whether HITL intervention is needed (block 335).

FIG. 4 is a flowchart representative of example machine readable instructions and/or example operations 310 that may be executed, instantiated, and/or performed by programmable circuitry to implement the example dissonance regularization identifier circuitry 204 of FIG. 2. The machine readable instructions and/or the operations 310 of FIG. 4 begin at block 405, at which the dissonance regularization identifier circuitry 204 identifies evidence vector(s) produced by the EVDL neural network (e.g., using the EVDL-based multi-view data analyzer circuitry 110 of FIG. 1). In some examples, the dissonance regularization identifier circuitry 204 identifies evidential distributions corresponding to different viewpoint(s) (e.g., belief masses) (block 410), as previously described in connection with FIG. 2. Subsequently, the dissonance regularization identifier circuitry 204 defines a joint mass based on the belief masses (block 415) and determines a loss function constraint (block 420) that can be applied during viewpoint model training. In some examples, the dissonance regularization identifier circuitry 204 applies the identified loss function constraint to enforce minimization of conflicting Dirichlet beliefs during model training (block 425).

FIG. 5 is a flowchart representative of example machine readable instructions and/or example operations 320 that may be executed, instantiated, and/or performed by programmable circuitry to implement the example viewpoint model training circuitry 206 of FIG. 2. The machine readable instructions and/or the operations 320 of FIG. 5 begin at block 505, at which the viewpoint model training circuitry 206 accesses training data 228. The training data 228 can include image data including different views. The trainer 232 identifies data features represented by the training data 228 (block 510). In some examples, the training controller 230 instructs the trainer 232 to perform training of the neural network using the training data 228 to generate a viewpoint model 238 (block 515). For example, the training controller 230 implements a loss function constraint determined using the dissonance regularization identifier circuitry 204 during training to enforce minimization of conflicting Dirichlet beliefs. In some examples, additional training is performed to refine the model 238 (block 520).

FIG. 6 is a flowchart representative of example machine readable instructions and/or example operations 325 that may be executed, instantiated, and/or performed by programmable circuitry to implement the example belief synthesis generator circuitry 208 of FIG. 2. The machine readable instructions and/or the operations 325 of FIG. 3 begin at block 605, at which the belief synthesis generator circuitry 208 defines belief synthesis (block 605), as previously described in connection with FIG. 2. The belief synthesis generator circuitry 208 proceeds to apply uninformed prior regularization to regularize the viewpoint model(s) (block 610). For example, the belief synthesis generator circuitry 208 reduces the instance of the spurious evidence being generated by the model in the case of misclassification by penalizing generation of evidence for misclassified data (block 615). In some examples, each viewpoint model (e.g., based on a temporal convolutional network) is regularized based on the belief synthesis described herein.

FIG. 7 is a flowchart representative of example machine readable instructions and/or example operations 330 that may be executed, instantiated, and/or performed by programmable circuitry to implement the example vacuity identifier circuitry 210 of FIG. 2. The machine readable instructions and/or the operations 330 of FIG. 3 begin at block 705, at which the vacuity identifier circuitry 210 determines a higher order system uncertainty based on a total vacuity (block 705), as described in connection with FIG. 2. In some examples, the HITL intervention notifier circuitry 212 identifies a total vacuity threshold indicating need for HITL intervention based on human annotation or guidance (block 710). If the threshold for intervention is met, the HITL intervention notifier circuitry 212 proceeds to prompt human intervention (block 720). For example, as previously described, uncertainty prediction represents a new frontier of vital importance to the usability of future AI systems. Uncertainty prediction embodies the potential to improve DL models in a multitude of important ways, including fostering better user trust in safety critical and related domains, facilitating HITL applications and the “virtuous” human-machine data cycle, improving model interpretability, advancing model calibration performance, enhancing anomaly detection and data exploration tasks, enabling higher-order cognitive modeling paradigms, such as opinion/belief state formulation, holistic scene understanding, as well as progressing bottom-line predictive model performance. Additionally, methods and apparatus disclosed herein can be deployed as part of projects exploring human/AI collaboration in the context of smart manufacturing applications for purposes of anomaly detection, dynamic multi-modal fusion, and belief synthesis.

As described in connection with FIG. 7, methods and apparatus disclosed herein improve the facilitation of human-interaction for improved system performance and assist in scaling efficiency using techniques such as continual learning. For example, methods and apparatus disclosed herein can be used to (1) estimate per-modality uncertainty and (2) combine different data modalities uncertainties into a unified framework. Unlike conventional statistical approaches that assume a single frame of reference, methods and apparatus disclosed herein determine uncertainty using multiple frames of reference (i.e., multi-modal data). As such, methods and apparatus disclosed herein can be used to (1) assess total system uncertainty for action recognition (e.g., using total vacuity) to trigger human intervention to help resolve uncertainties (e.g., via a verbal cue), (2) identify data anomalies, and (3) aid in data efficient active learning to improve the scaling of a given system to new tasks/domains by identifying knowledge gaps in the system.

FIG. 8A illustrates an example diagram 800 of an example three-dimensional confident Dirichlet prediction 805, an example conflicting Dirichlet prediction 810, and an example out-of-distribution Dirichlet prediction 815. As previously described in connection with FIG. 1, for a small number of dimensions (i.e., small k), the support and morphology of the Dirichlet can be visualized explicitly with regard to a k-simplex (e.g., a 3-simplex), such that instances of the Dirichlet distribution with different parameter values are shown to encapsulate cases reflecting confident predictions (e.g., α=<50,1,1>), (in distribution) conflicting predictions (e.g., α=<50,50,50>), and out-of-distribution (OOD) predictions (e.g., α=<1,1,1>).

FIG. 8B illustrates an example diagram 850 of an example confident prediction 855, an example conflicting prediction 860, and a Dirichlet prediction using Evidential Deep Learning (EVDL) 865. For example, FIG. 8B includes example Dirichlet distributions and their corresponding vacuity and dissonance scores. FIG. 8B furthermore highlights failures of conventional uncertainty measures, including entropy, to capture the difference between in-distribution and OOD, and sharp conflict prediction cases. In the example of FIG. 8B, the vector u indicates, component-wise: (1) vacuity, (2) dissonance, (3) aleatoric uncertainty, (4) epistemic uncertainty, and (5) entropy.

FIG. 9 illustrates an example diagram 900 showing example entropy 905, example dissonance 910, and example vacuity 915 in an EVDL framework showing degrees of uncertainty 920 (e.g., from low uncertainty to high uncertainty). For example, FIG. 9 includes an idealized image encapsulating the key features of dissonance and vacuity in the EVDL framework. Whereas entropy treats the cases of conflicting evidence and novel/ODD identically, EVDL provides a more nuanced lens for uncertainty. Ideally, dissonance quantifies evidential disagreement between class predictions, while vacuity quantifies an overall lack of evidence.

FIG. 10 illustrates a baseline schematic for experimental action recognition workflow 1000 using a three-dimensional convolutional neural network backbone, temporal convolutional network streams, and a multi-view belief synthesis process in accordance with teachings disclosed herein. In the example of FIG. 10, the multi-view data input 105 of FIG. 1 includes a first view 1005 and a second view 1010. The first and second views 1005, 1010 are input into an example three-dimensional convolutional neural network (CNN) 1015 to generate a prediction associated with the processed input view(s). The results of the CNN-based processing are passed to the uncertainty estimator circuitry 115 to perform dissonance regularization, viewpoint model training, belief synthesis generation, and vacuity identification. For example, the viewpoint model(s) can be trained using a temporal convolutional network (TCN), where each input view has a separately-trained viewpoint model 1025, 1030. The multi-view dissonance regularization identifier circuitry 204 identifies a joint mass 1045 based on belief masses 1035, 1040 to determine a loss function constraint. For example, the dissonance regularization identifier circuitry 204 follows Dempster's combination rule for fusing independent beliefs. Given two belief masses (i.e., evidential distributions corresponding with different viewpoints) denoted M¹={{bₖ¹}ₖ₌₁^{K}, u¹} and M²={{bₖ²}ₖ₌₁^{K}, u²}, respectively, the dissonance regularization identifier circuitry 204 determines a joint mass in accordance with Equation 8, as described in more detail in connection with FIG. 2.

FIG. 11 illustrates example performance results 1100, 1150 for baseline multi-view belief synthesis (MVBS) and total vacuity (TV) for human-in-the-loop (HITL) intervention. For example challenging, real-world manufacturing data can be selected consisting of over 25 video clips (e.g., over 100,000 individual video frames) for the downstream task of fine-grain video action segmentation. An example dataset consists of 13 individual class actions. A pre-trained Slow-Fast 50 3D CNN architecture is used to extract global frame-wise features from raw video. For the final action segmentation inference, a state-of-the-art TCN MSTCN++ model is trained from scratch, with the training of an independent TCN for each viewpoint stream, as shown in connection with FIG. 10. In the example of FIG. 11, models 1105 used include the multi-view belief synthesis (MVBS) model disclosed herein, and models 1150 include the uninformed prior for belief synthesis (UPBS)-based models disclosed herein. An example per frame accuracy 1110 is shown in addition to example F1 scores 1115, 1120, 1125, which represent the number of prediction errors made by the model(s) 1105, 1155 and the type of errors made by the model(s) 1105, 1155.

FIG. 12 is a block diagram of an example programmable circuitry platform 1200 structured to execute and/or instantiate the example machine-readable instructions and/or the example operations of FIGS. 3, 4, 6, and/or 7 to implement the example uncertainty estimator circuitry 115. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs microprocessors, CPUs, GPUs, DSPs, and/or microcontrollers from any desired family or manufacturer. The programmable circuitry 1212 may be implemented by one or more semiconductor based (e.g., silicon based) devices. In this example, the processor circuitry 1212 implements the input identifier circuitry 202, the dissonance regularization identifier circuitry 204, the viewpoint model training circuitry 206, the belief synthesis generator circuitry 208, the vacuity identifier circuitry 210, and/or the HITL intervention notifier circuitry.

The programmable circuitry 1212 of the illustrated example includes a local memory 1213 (e.g., a cache, registers, etc.). The programmable circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1200 of the illustrated example also includes one or more mass storage devices 1228 to store software and/or data. Examples of such mass storage devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1232, which may be implemented by the machine readable instructions of FIGS. 3, 4, 6, and/or 7, may be stored in the mass storage device 1228, in the volatile memory 1214, in the non-volatile memory 1216, and/or on at least one non-transitory computer readable storage medium such as a CD or DVD which may be removable.

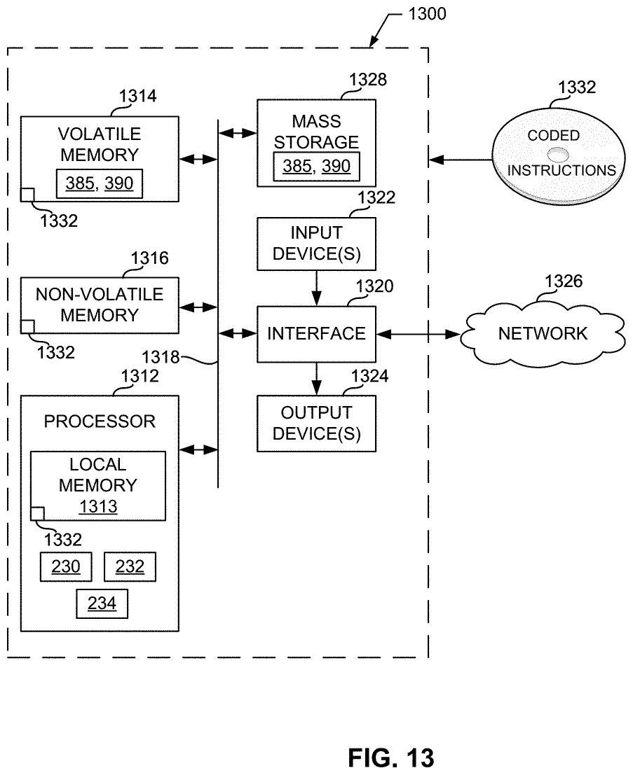

FIG. 13 is a block diagram of an example programmable circuitry platform 1300 structured to execute and/or instantiate the example machine-readable instructions and/or the example operations of FIG. 5 to implement the example computing system 225 of FIG. 2. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example neural network processor 234, the example trainer 232, and the example training controller 230.

The programmable circuitry 1312 of the illustrated example includes a local memory 1313 (e.g., a cache, registers, etc.). The programmable circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output devices 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1300 of the illustrated example also includes one or more mass storage devices 1328 to store software and/or data. Examples of such mass storage devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1332, which may be implemented by the machine readable instructions of FIG. 5, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1212, 1312 of FIGS. 12 and 13. In this example, the programmable circuitry 1212, 1312 of FIGS. 12 and 13 is implemented by a microprocessor 1400. For example, the microprocessor 1400 may be a general purpose microprocessor (e.g., general purpose microprocessor circuitry). The microprocessor 1400 executes some or all of the machine readable instructions of the flowchart of FIGS. 3, 4, 5, 6, and/or 7 to effectively instantiate the circuitry of FIG. 2 logic circuits to perform the operations corresponding to those machine readable instructions. In some such examples, the circuitry of FIG. 2 is instantiated by the hardware circuits of the microprocessor 1400 in combination with the instructions. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 3, 4, 5, 6 and/or 7.

The cores 1402 may communicate by a first example bus 1404. In some examples, the first bus 1404 may implement a communication bus to effectuate communication associated with one(s) of the cores 1402. For example, the first bus 1404 may implement at least one of an Inter-Integrated Circuit (I2C) bus, a Serial Peripheral Interface (SPI) bus, a PCI bus, or a PCIe bus. Additionally or alternatively, the first bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer-based operations. In other examples, the AL circuitry 1416 also performs floating-point operations. In yet other examples, the AL circuitry 1416 may include first AL circuitry that performs integer-based operations and second AL circuitry that performs floating point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry of FIGS. 12-13. In this example, the programmable circuitry 1212, 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 3, 4, 5, 6, and/or 7 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 3, 4, 5, 6, and/or 7. In particular, the FPGA 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 3, 4, 5, 6, and/or 7. As such, the FPGA circuitry 1500 may be configured and/or structured to effectively instantiate some or all of the operations/functions corresponding to the machine readable instructions of the flowcharts of FIGS. 3, 4, 5, 6, and/or 7 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 3, 4, 5, 6, and/or 7 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 3, 4, 5, 6, and/or 7 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1212, 1312 of FIGS. 12-13, many other approaches are contemplated. For example, FPGA circuitry may include an on-board CPU, such as one or more of the example CPU 1520 of FIG. 15. Therefore, the programmable circuitry 1212, 1312 of FIGS. 12-13 may additionally be implemented by combining at least the example microprocessor 1400 of FIG. 14 and the example FPGA circuitry 1500 of FIG. 15. In some such hybrid examples, one or more cores 1502 of FIG. 15 may execute a first portion of the machine readable instructions represented by the flowchart(s) of FIGS. 3, 4, 5, 6, and/or 7 to perform first operation(s)/function(s), the FPGA circuitry 1500 of FIG. 15 may be configured and/or structured to perform second operation(s)/function(s) corresponding to a second portion of the machine readable instructions represented by the flowcharts of FIGS. 3, 4, 5, 6, and/or 7, and/or an ASIC may be configured and/or structured to perform third operation(s)/function(s) corresponding to a third portion of the machine readable instructions represented by the flowcharts of FIGS. 3, 4, 5, 6, and/or 7.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1212, 1312 of FIGS. 12-13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1212, 1312 of FIGS. 12-13 which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

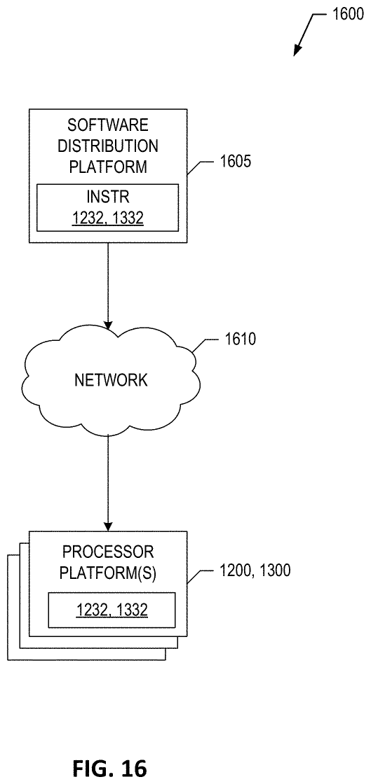

A block diagram illustrating an example software distribution platform 1605 to distribute software such as the example machine readable instructions 1232, 1332 of FIGS. 12-13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1232, 1332 of FIGS. 12-13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1232, 1332, which may correspond to the example machine readable instructions of FIGS. 3-7, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232, 1332 from the software distribution platform 1605. For example, the software, which may correspond to the example machine readable instructions of FIG. 3-7, may be downloaded to the example programmable circuitry platform 1200, which is to execute the machine readable instructions 1232 to implement the uncertainty estimator circuitry 115. In some examples, one or more servers of the software distribution platform 1605 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that permit uncertainty estimation for human-in-the-loop automation using multi-view belief synthesis. In examples disclosed herein, multi-view dissonance regularization, uniformed priors for belief synthesis, and total vacuity for HITL applications is achieved. For example, an end-to-end system leveraging lightweight, Temporal Convolutional Networks (TCNs) is introduced along with a framework for enabling HITL applications using estimated total vacuity of the multi-view automated system. In examples disclosed herein, dissonance regularization applies an additional learning constraint via a loss function to enforce the minimization of conflicting Dirichlet beliefs during model training, uniformed priors for belief synthesis enrich the fused evidential distributions learned by the system by penalizing the generation of evidence for misclassified data, and total vacuity provides an effective means to identify high degrees of epistemic uncertainty to prompt HITL intervention.

Example methods, apparatus, systems, and articles of manufacture for efficient execution of convolutional neural networks for compressed video sequences are disclosed herein. Further examples and combinations thereof include the following:

Example 1 includes an apparatus, comprising at least one memory, machine readable instructions, and programmable circuitry to at least one of instantiate or execute the machine readable instructions to receive input from a deep learning network, perform dissonance regularization to the input from the deep learning network, the dissonance regularization including a multi-view belief fusion, identify a loss function constraint based on the dissonance regularization, apply the identified loss function constraint during training of a viewpoint model, and initiate at least one user intervention based on a total vacuity threshold, the total vacuity threshold associated with the multi-view belief fusion.

Example 2 includes the apparatus of example 1, wherein the programmable circuitry is to identify a joint mass based on a first belief mass and a second belief mass, the first belief mass and the second belief mass determined using input from the deep learning network, the input including a convolutional neural network-based prediction.

Example 3 includes the apparatus of example 2, wherein the first belief mass is associated with an input of a first view and the second belief mass is associated with an input of a second view, the first view and the second view including video sequence image data.

Example 4 includes the apparatus of example 1, wherein the programmable circuitry is to decrease conflicting Dirichlet beliefs by applying the identified loss function constraint during the training of the viewpoint model.

Example 5 includes the apparatus of example 1, wherein the dissonance regularization is uninformed prior regularization to regularize the viewpoint model, viewpoint model regularization including a decrease in generation of model-based spurious evidence.

Example 6 includes the apparatus of example 1, wherein the programmable circuitry is to determine a higher order system uncertainty based on a total vacuity of multi-view automation.

Example 7 includes the apparatus of example 1, wherein the programmable circuitry is to prompt the at least one user intervention for high degrees of epistemic uncertainty, the epistemic uncertainty representative of model uncertainty.

Example 8 includes a method comprising receiving, by executing an instruction with at least one processor, input from a deep learning network, performing, by executing an instruction with at least one processor, dissonance regularization to the input from the deep learning network, the dissonance regularization including a multi-view belief fusion, identifying, by executing an instruction with at least one processor, a loss function constraint based on the dissonance regularization, applying, by executing an instruction with at least one processor, the identified loss function constraint during training of a viewpoint model, and initiating, by executing an instruction with at least one processor, at least one user intervention based on a total vacuity threshold, the total vacuity threshold associated with the multi-view belief fusion.

Example 9 includes the method of example 8, further including identifying a joint mass based on a first belief mass and a second belief mass, the first belief mass and the second belief mass determined using input from the deep learning network, the input including a convolutional neural network-based prediction.

Example 10 includes the method of example 9, wherein the first belief mass is associated with an input of a first view and the second belief mass is associated with an input of a second view, the first view and the second view including video sequence image data.

Example 11 includes the method of example 8, further including decreasing conflicting Dirichlet beliefs by applying the identified loss function constraint during the training of the viewpoint model.

Example 12 includes the method of example 8, wherein the dissonance regularization is uninformed prior regularization to regularize the viewpoint model, viewpoint model regularization including a decrease in generation of model-based spurious evidence.

Example 13 includes the method of example 8, further including determining a higher order system uncertainty based on a total vacuity of multi-view automation.

Example 14 includes the method of example 8, further including prompting the at least one user intervention for high degrees of epistemic uncertainty, the epistemic uncertainty representative of model uncertainty.

Example 15 includes a non-transitory machine readable storage medium comprising instructions to cause programmable circuitry to at least receive input from a deep learning network, perform dissonance regularization to the input from the deep learning network, the dissonance regularization including a multi-view belief fusion, identify a loss function constraint based on the dissonance regularization, apply the identified loss function constraint during training of a viewpoint model, and initiate at least one user intervention based on a total vacuity threshold, the total vacuity threshold associated with the multi-view belief fusion.

Example 16 includes the non-transitory machine readable storage medium of example 15, wherein the instructions are to cause the programmable circuitry to identify a joint mass based on a first belief mass and a second belief mass, the first belief mass and the second belief mass determined using input from the deep learning network, the input including a convolutional neural network-based prediction.

Example 17 includes the non-transitory machine readable storage medium of example 16, wherein the first belief mass is associated with an input of a first view and the second belief mass is associated with an input of a second view, the first view and the second view including video sequence image data.

Example 18 includes the non-transitory machine readable storage medium of example 15, wherein the instructions are to cause the programmable circuitry to decrease conflicting Dirichlet beliefs by applying the identified loss function constraint during the training of the viewpoint model.

Example 19 includes the non-transitory machine readable storage medium of example 15, wherein the dissonance regularization is uninformed prior regularization to regularize the viewpoint model, viewpoint model regularization including a decrease in generation of model-based spurious evidence.

Example 20 includes the non-transitory machine readable storage medium of example 15, wherein the instructions are to cause the programmable circuitry to determine a higher order system uncertainty based on a total vacuity of multi-view automation.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
at least one memory;
machine readable instructions; and
programmable circuitry to at least one of instantiate or execute the machine readable instructions to:
receive input from a deep learning network;
perform dissonance regularization to the input from the deep learning network, the dissonance regularization including a multi-view belief fusion;
identify a loss function constraint based on the dissonance regularization;
apply the identified loss function constraint during training of a viewpoint model; and
initiate at least one user intervention based on a total vacuity threshold, the total vacuity threshold associated with the multi-view belief fusion.

2. The apparatus of claim 1, wherein the programmable circuitry is to identify a joint mass based on a first belief mass and a second belief mass, the first belief mass and the second belief mass determined using input from the deep learning network, the input including a convolutional neural network-based prediction.

3. The apparatus of claim 2, wherein the first belief mass is associated with an input of a first view and the second belief mass is associated with an input of a second view, the first view and the second view including video sequence image data.

4. The apparatus of claim 1, wherein the programmable circuitry is to decrease conflicting Dirichlet beliefs by applying the identified loss function constraint during the training of the viewpoint model.

5. The apparatus of claim 1, wherein the dissonance regularization is uninformed prior regularization to regularize the viewpoint model, viewpoint model regularization including a decrease in generation of model-based spurious evidence.

6. The apparatus of claim 1, wherein the programmable circuitry is to determine a higher order system uncertainty based on a total vacuity of multi-view automation.

7. The apparatus of claim 1, wherein the programmable circuitry is to prompt the at least one user intervention for high degrees of epistemic uncertainty, the epistemic uncertainty representative of model uncertainty.

8. A method comprising:
receiving, by executing an instruction with at least one processor, input from a deep learning network;
performing, by executing an instruction with at least one processor, dissonance regularization to the input from the deep learning network, the dissonance regularization including a multi-view belief fusion;
identifying, by executing an instruction with at least one processor, a loss function constraint based on the dissonance regularization;
applying, by executing an instruction with at least one processor, the identified loss function constraint during training of a viewpoint model; and
initiating, by executing an instruction with at least one processor, at least one user intervention based on a total vacuity threshold, the total vacuity threshold associated with the multi-view belief fusion.

9. The method of claim 8, further including identifying a joint mass based on a first belief mass and a second belief mass, the first belief mass and the second belief mass determined using input from the deep learning network, the input including a convolutional neural network-based prediction.

10. The method of claim 9, wherein the first belief mass is associated with an input of a first view and the second belief mass is associated with an input of a second view, the first view and the second view including video sequence image data.

11. The method of claim 8, further including decreasing conflicting Dirichlet beliefs by applying the identified loss function constraint during the training of the viewpoint model.

12. The method of claim 8, wherein the dissonance regularization is uninformed prior regularization to regularize the viewpoint model, viewpoint model regularization including a decrease in generation of model-based spurious evidence.

13. The method of claim 8, further including determining a higher order system uncertainty based on a total vacuity of multi-view automation.

14. The method of claim 8, further including prompting the at least one user intervention for high degrees of epistemic uncertainty, the epistemic uncertainty representative of model uncertainty.

15. A non-transitory machine readable storage medium comprising instructions to cause programmable circuitry to at least:
receive input from a deep learning network;
perform dissonance regularization to the input from the deep learning network, the dissonance regularization including a multi-view belief fusion;
identify a loss function constraint based on the dissonance regularization;
apply the identified loss function constraint during training of a viewpoint model; and
initiate at least one user intervention based on a total vacuity threshold, the total vacuity threshold associated with the multi-view belief fusion.

16. The non-transitory machine readable storage medium of claim 15, wherein the instructions are to cause the programmable circuitry to identify a joint mass based on a first belief mass and a second belief mass, the first belief mass and the second belief mass determined using input from the deep learning network, the input including a convolutional neural network-based prediction.

17. The non-transitory machine readable storage medium of claim 16, wherein the first belief mass is associated with an input of a first view and the second belief mass is associated with an input of a second view, the first view and the second view including video sequence image data.

18. The non-transitory machine readable storage medium of claim 15, wherein the instructions are to cause the programmable circuitry to decrease conflicting Dirichlet beliefs by applying the identified loss function constraint during the training of the viewpoint model.

19. The non-transitory machine readable storage medium of claim 15, wherein the dissonance regularization is uninformed prior regularization to regularize the viewpoint model, viewpoint model regularization including a decrease in generation of model-based spurious evidence.

20. The non-transitory machine readable storage medium of claim 15, wherein the instructions are to cause the programmable circuitry to determine a higher order system uncertainty based on a total vacuity of multi-view automation.
